(19) United States
(12) Patent Application Publication
(10) Pub. No.: US 2012/0226428 A1
(43) Pub. Date: Sep. 6, 2012

(54) METHOD FOR THE OPEN-LOOP CONTROL AND CLOSED-LOOP CONTROL OF AN INTERNAL COMBUSTION ENGINE

(75) Inventor: Armin Dölker, Friedrichshafen (DE)

(73) Assignee: MTU FRIEDRICHSHAFEN GMBH, Friedrichshafen (DE)

(21) Appl. No.: 13/503,545

(22) PCT Filed: Oct. 19, 2010
(86) PCT No.: PCT/EP2010/006383

§ 371 Date: May 11, 2012

(30) Foreign Application Priority Data
Oct. 23, 2009 (DE) 10 2009 050 469.9

(51) Int. Cl. F02D 41/26; F02D 41/30

(52) U.S. Cl. 701/103

(57) ABSTRACT

The invention relates to a method for the open-loop control and the closed-loop control of an internal combustion engine (1) comprising an A-side and a B-side common rail system, the rail pressure (pCR(A)) of the common rail system on the A side being controlled via an A-side rail pressure control loop in a closed loop mode and the rail pressure (pCR(B)) of the common rail system on the B side being controlled via a B-side rail pressure control loop in a closed loop mode independently of each other. The invention is characterized in that once a defective A-side rail pressure sensor (8A) is detected, an A-side emergency operation mode is activated in which the A-side rail pressure (pCR(A)) is controlled in an open loop mode and the B-side rail pressure (pCR(BB)) is continued to be controlled in a closed loop mode, or once a defective B-side rail pressure sensor (8B) is detected, a B-side emergency operation mode is activated in which the B-side rail pressure (pCR(B)) is controlled in an open loop mode and the A-side rail pressure (pCR(A)) is continued to be controlled in a closed loop mode.

The invention concerns a method for the open-loop and closed-loop control of an internal combustion engine, in which an A-side rail pressure is automatically controlled independently of the B-side rail pressure.

In an internal combustion engine with a common rail system, the quality of combustion is critically determined by the pressure level in the rail. Therefore, in order to stay within legally prescribed emission limits, the rail pressure is automatically controlled. A closed-loop rail pressure control system typically comprises a comparison point for determining a control deviation, a pressure controller for computing a control signal, the controlled system, and a software filter in the feedback path for computing the actual rail pressure in the feedback path. The control deviation in turn is computed as the difference between a set rail pressure and the actual rail pressure. The controlled system comprises the pressure regulator, the rail, and the injectors for injecting the fuel into the combustion chambers of the internal combustion engine.

DE 10 2006 040 441 B3 describes a common rail system with closed-loop pressure control, in which the pressure controller acts on a suction throttle by means of a control signal. The suction throttle determines the admission cross section to the high-pressure pump and thus the volume of fuel delivered. The suction throttle is actuated in negative logic, i.e., it is completely open at a current value of zero amperes. As a protective measure against excessively high rail pressure, for example, after a cable break in the power supply to the suction throttle, a passives pressure control valve is provided. If the rail pressure rises above a critical value, for example, 2400 bars, the pressure control vale opens. The fuel is then redirected from the rail to the fuel tank through the open pressure control valve. With the pressure control valve open, a pressure level develops in the rail which depends on the injection quantity and the engine speed. Under idling conditions, this pressure level is about 900 bars, but under a full load, it is about 700 bars.

DE 10 2007 034 317 A1 describes an internal combustion engine with an A-side and a B-side common rail system. The two common rail systems are hydraulically decoupled from each other and therefore allow independent closed-loop control of the A-side and B-side rail pressure. Pressure fluctuation in the rails are reduced by the separate closed-loop control. Correct closed-loop rail pressure control requires properly operating rail pressure sensors. The failure of one rail pressure sensor or both rail pressure sensors in the specified system results in an undefined state of closed-loop pressure control and can produce a critical state of the internal combustion engine, since the cited document fails to indicate any fault safeguards.

Proceeding from a common rail system with a passive pressure control valve and an independent closed-loop rail pressure control system on both the A side and the B side, the objective of the invention is to guarantee reliable engine operation after failure of a rail sensor.

This objective is achieved by a method for the open-loop and closed-loop control of an internal combustion engine with the features of claim 1. Refinements are described in the dependent claims.

The method of the invention is characterized in that the rail pressure which can be detected without error continues to be controlled by closed-loop control, while the rail pressure which can no longer be detected is controlled by open-loop control in emergency operating mode. If, for example, a defective A-side rail pressure sensor is detected, a change is made to emergency operating mode on the A side, in which the A-side rail pressure is controlled by open-loop control, while the B-side rail pressure continues to be controlled by closed-loop control. If, on the other hand, the B-side rail pressure sensor is defective, a change is made to emergency operating mode on the B side, in which the B-side rail pressure is controlled by open-loop control, while the A-side rail pressure continues to be controlled by closed-loop control. If double failure occurs, i.e., both rail pressure sensors are defective, a change is made to emergency operating mode on both the A side and the B side.

In A-side emergency operating mode, the A-side rail pressure is successively increased until the A-side passive pressure control valve responds, which then causes fuel to be redirected from the A-side rail into the fuel tank. With the A-side pressure control valve open, a rail pressure in the range of 700 bars (full load) to 900 bars (idle) then develops in the A-side rail. An analogous procedure is followed in B-side emergency operating mode. Reliable engine operation is thus realized by virtue of the fact that the intentionally effected opening of the pressure control valve in the establishment of a defined state. In the case of a single failure, since the properly operating rail continues to be controlled by closed-loop control, it is operated with the best possible emission values, and this allows continued operation of the internal combustion engine with comparatively high output. In the event of a double failure, the internal combustion engine can continue to be operated at reduced output.

The successive pressure increase in emergency operating mode is realized by acting on the suction throttle in the opening direction. The suction throttle, which is on the low-pressure side, serves as the pressure regulator. This is accomplished, for example, by setting a set current or a PWM signal as a triggering signal of the suction throttle to a suitable emergency operating value. In the case of a suction throttle that is open in the absence of current, a current value of, for example, zero amperes is set in emergency operating mode. Opening of the passive pressure control valve can also be realized if a emergency operation current value greater than zero is set, e.g., 0.4 A. This makes it possible to reduce the amount of heating of the fuel.

In normal operating mode, the energization time of the injectors is computed by an injector input-output map as a function of a set injection quantity and the respective actual rail pressure. If an A-side injector is to be activated, this is the A-side actual rail pressure. If a B-side injector is to be activated, this is the B-side actual rail pressure. Switching from the A-side actual rail pressure to the B-side actual rail pressure occurs as a function of the firing order. Therefore, a defective rail pressure sensor causes a faulty energization time. The invention now provides that in A-side emergency operating mode, instead of the A-side actual rail pressure, a rail pressure mean value is set as the input variable of the injector input-output map. It is advantageous to set the rail pressure mean pressure at 800 bars in conformity with the pressure range referred to above. If the B-side rail pressure sensor fails, the rail pressure mean value is likewise set instead of the B-side actual rail pressure. In the event of double failure, the energization time is computed as a function of the set injection quantity and the rail pressure mean value, independently of the firing order. The advantage of this procedure is that even after failure of one or both of the rail pressure sensors, the energization time of the injectors can still be determined with sufficient accuracy.

The figures illustrate a preferred embodiment of the invention.

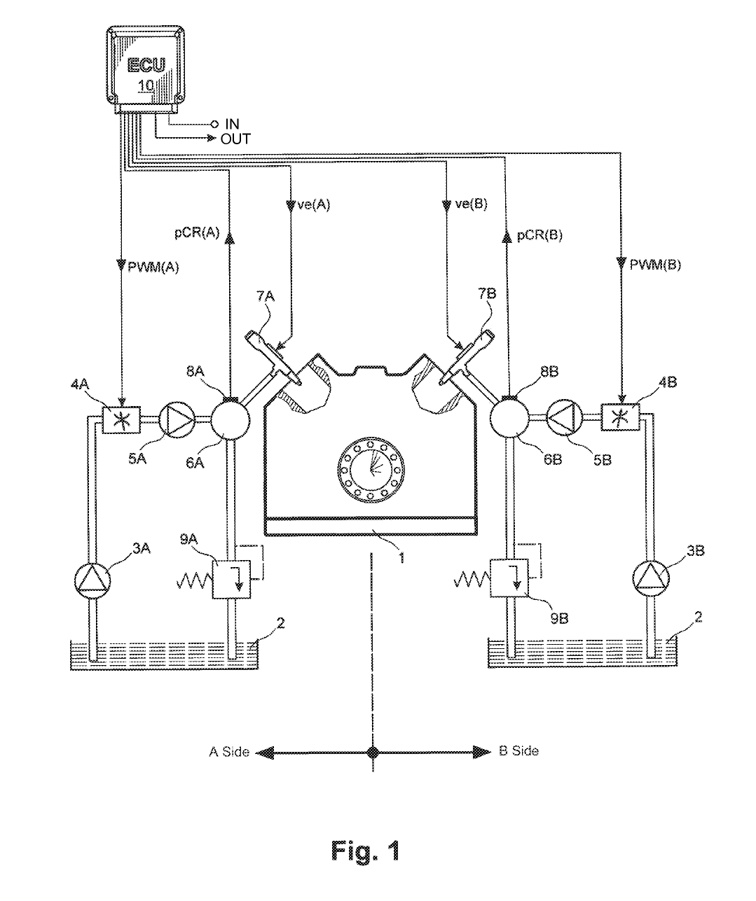

FIG. 1 is a system diagram.

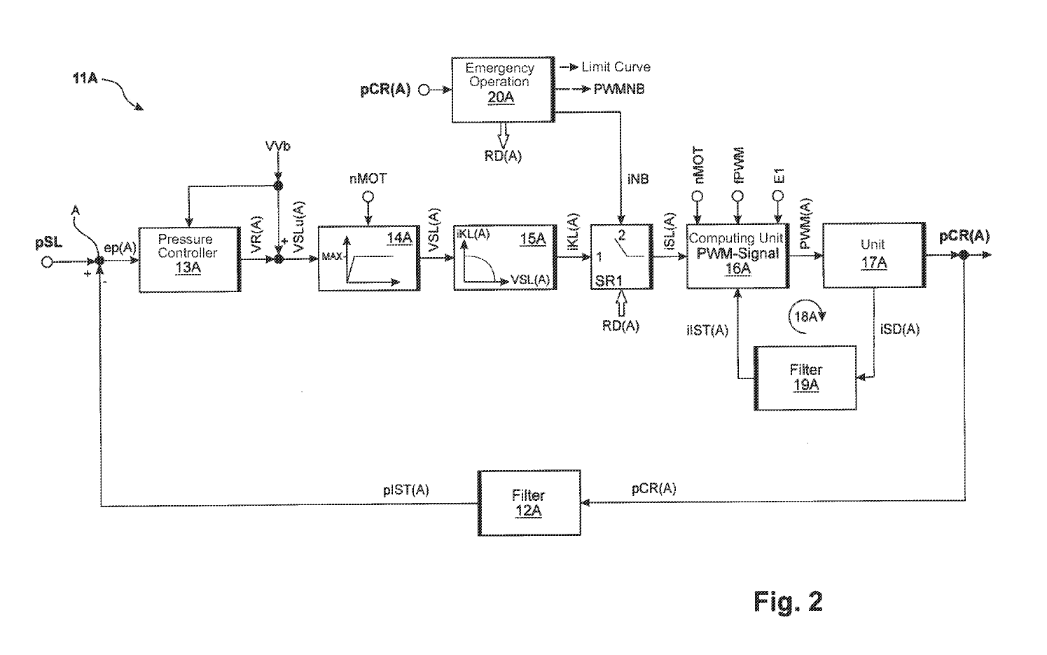

FIG. 2 is the A-side closed-loop rail pressure control system with emergency operating mode.

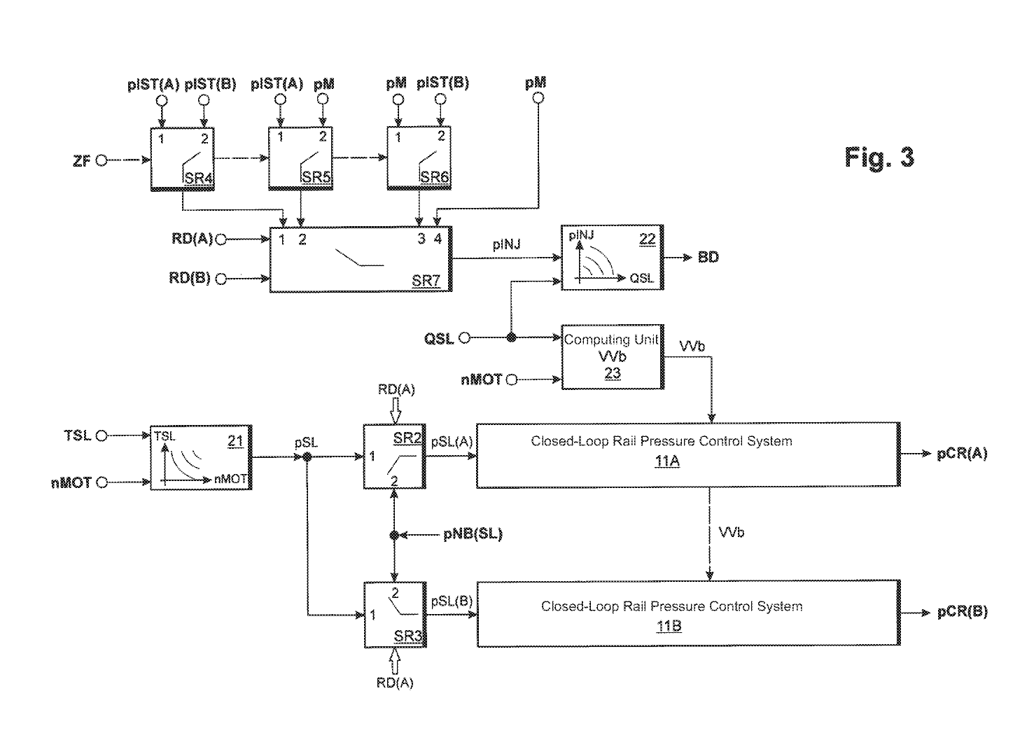

FIG. 3 is a block diagram.

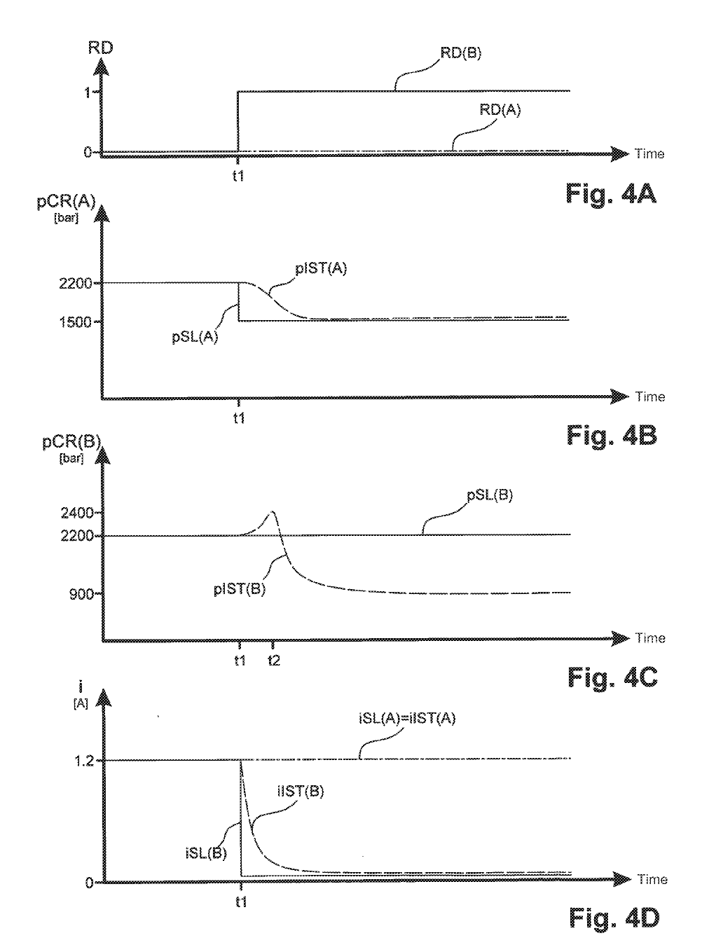

FIG. 4 is a time chart.

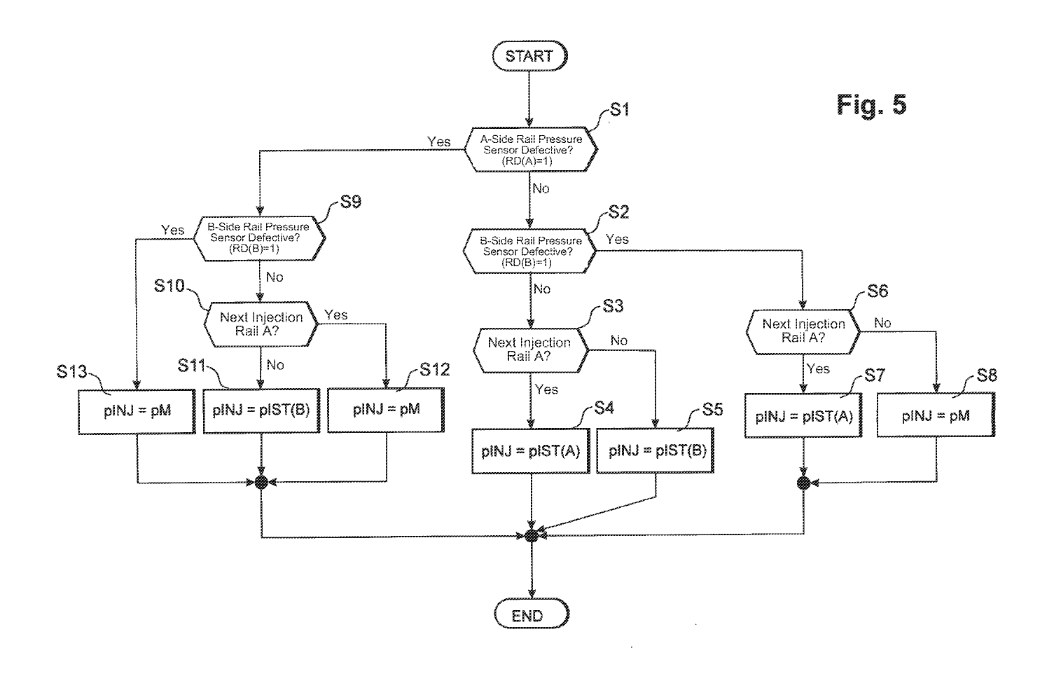

FIG. 5 is a first program flowchart.

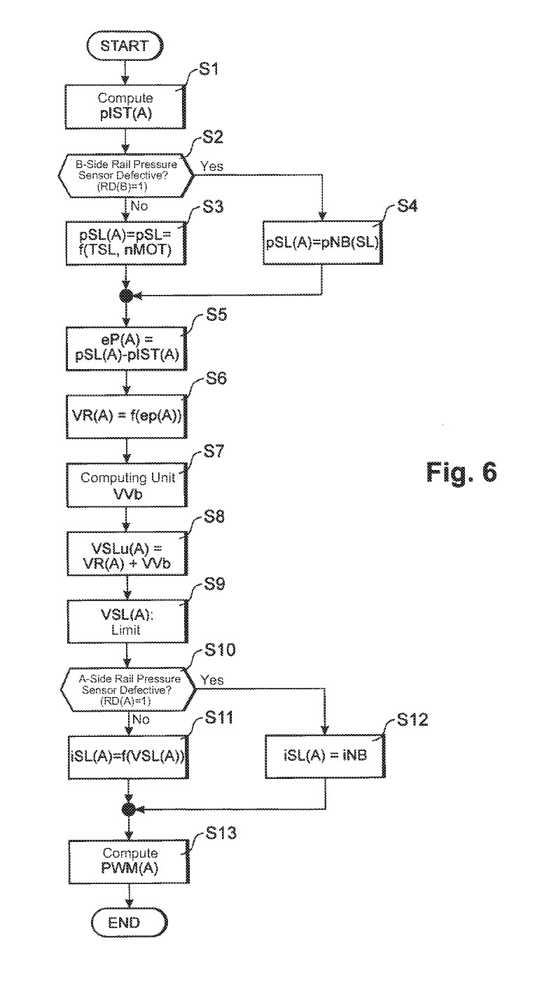

FIG. 6 is a second program flowchart.

FIG. 1 shows a system diagram of an electronically controlled V-type internal combustion engine 1 with a common rail system on the A side and a common rail system on the B side. The A-side and B-side common rail systems are identical in structure. In the description which follows, the components on the A side are identified by reference numbers with the suffix A, and the components on the B side are identified by reference numbers with the suffix B.

The common rail system on the A side comprises the following mechanical components: a low-pressure pump 3A for pumping fuel from a fuel tank 2, a suction throttle 4A for controlling the volume flow, a high-pressure pump 5A, a rail 6A, and injectors 7A for injecting fuel into the combustion chambers of the internal combustion engine 1. Optionally, the common rail system can also be realized with individual accumulators, in which case an individual accumulator is then integrated, for example, in the injector 7A as additional buffer volume. To protect against an impermissibly high pressure level in the rail 6A, a passive pressure control valve 9A is provided, which opens, for example, at a rail pressure of 2400 bars and, in its open state, redirects the fuel from the rail 6A into the fuel tank 2.

The internal combustion engine 1 is controlled by an electronic engine control unit (ECU) 10, which contains the usual components of a microcomputer system, for example, a microprocessor, interface adapters, buffers, and memory components (EEPROM, RAM). Operating characteristics that are relevant to the operation of the internal combustion engine 1 are applied in the memory components in the form of input-output maps/characteristic curves. The electronic control unit 10 uses these to compute the output variables from the input variables. FIG. 1 shows the following input variables of the electronic engine control unit 10 as examples: an A-side rail pressure pCR(A), a B-side rail pressure pCR(B), and an input variable EIN. The A-side rail pressure pCR(A) is detected by an A-side rail pressure sensor 8A, and the B-side rail pressure pCR(B) is detected by a B-side rail pressure sensor 8B. The input variable EIN is representative of the other input signals, for example, an engine speed or an engine power output desired by the operator. The illustrated output variables of the electronic control unit 10 are a PWM signal PWM(A) for controlling the A-side suction throttle 4A, a power-determining signal ve(A) for controlling the A-side injectors 7A, a PWM signal PWM(B) for controlling the B-side suction throttle 4B, a power-determining signal ve(B) for controlling the B-side injectors 7B, and an output variable AUS. The latter represents additional control signals for automatically controlling the internal combustion engine 1, for example, a control signal for controlling an EGR valve. The characterizing feature of the present embodiment of the invention is the mutually independent closed-loop control of the A-side rail pressure pCR(A) and the B-side rail pressure pCR(B).

FIG. 2 shows the A-side closed-loop rail pressure control system 11A for the closed-loop control of the A-side rail pressure pCR(A) with emergency operating mode. Since the A-side closed-loop rail pressure control system and the B-side closed-loop rail pressure control system are identical in structure, the description of FIG. 2 applies equally to the B-side closed-loop rail pressure control system. The input variables of the A-side closed-loop rail pressure control system 11A are: a set rail pressure pSL, a set consumption VVb, the engine speed nMOT, a signal RD(A), an emergency operation current value iNB, a PWM base frequency fPWM, and an input variable E1. The input variable E1 combines, for example, the battery voltage and the ohmic resistance of the suction throttle coil with lead-in wire, which enter into the computation of the PWM signal. The signal RD(A) characterizes a defective A-side rail pressure sensor. The output variable of the A-side closed-loop rail pressure control system 11A is the raw value of the A-side rail pressure pCR(A). A filter 12A uses the raw value of the A-side rail pressure pCR(A) to compute the actual rail pressure pIST(A). The latter is then compared with the set rail pressure pSL at a summation point A, and a control deviation ep(A) is obtained from this comparison. A correcting variable is computed from the control deviation ep(A) by a pressure controller 13A. The correcting variable represents a controller volume flow VR(A) with the physical unit of liters/minute. The computed set consumption VVb is added to the controller volume flow VR(A) at a summation point. The set consumption VVb is computed as a function of a set injection quantity and the engine speed (FIG. 3). The result of the addition represents an unlimited A-side set volume flow VSLu(A), which is then limited by a limiter 14A as a function of the engine speed nMOT. The output variable of the limiter 14A represents a set volume flow VSL(A), which is the input variable of a pump characteristic curve 15A. The pump characteristic curve 15A assigns an electric current iKL(A) to the set volume flow VSL(A). The pump characteristic curve 15A is realized in such a form that a decreasing current iKL(A) is assigned to an increasing set volume flow VSL(A). In normal operating mode, the switch SR1 is in position 1, so that the set current iSL(A) corresponds to the current iKL(A) computed by the pump characteristic curve 15A. The set current iSL(A) is one of the input variables of the PWM signal computing unit 16A. A PWM signal PWM(A) is computed by the computing unit 16A as a function of the set current iSL(A) and then activates the solenoid of the A-side suction throttle. The displacement of the magnetic core is varied in this way, so that the delivery flow of the A-side high-pressure pump is freely controlled. For safety reasons, the A-side suction throttle is open in the absence of current and with increasing PWM value is caused to move in the direction of the closed position. The A-side suction throttle and the A-side high-pressure pump are combined in the unit 17A. A closed-loop current control system 18A can be subordinate to the A-side suction throttle. In this closed-loop current control system 18A, the suction throttle current iSD(A) is detected as the controlled variable, filtered by a filter 19A, and fed back to the computing unit 16A as the actual current iIST(A). The A-side rail pressure pCR(A) produced by the high-pressure pump in the A-side rail is then detected by the A-side rail pressure sensor. The A-side closed-loop rail pressure control system is thus closed.

The A-side closed-loop rail pressure control system is supplemented by an emergency operation functional block 20A. Its input variable is the A-side rail pressure pCR(A). The functional block 20A has the following functionalities: monitoring of the A-side rail pressure sensor on the basis of the A-side rail pressure pCR(A), switching to the A-side emergency operating mode by setting the signal RD(A), and outputting an emergency operation triggering signal. In this regard, the emergency operation triggering signal is selected in such a way that the passive A-side pressure control valve 9(A) (FIG. 1) is reliably opened. If a defective A-side rail pressure sensor is detected, emergency operating mode is set in a two-step procedure. In a first step, the signal RD(A) is set, and in a second step, the emergency operation current value iNB is output as the emergency operation triggering signal. Setting the signal RD(A) causes the switch SR1 to switch to position 2, so that now the set current iSL(A) corresponds to the emergency operation current value iNB. If, as previously described, the suction throttle is actuated in negative logic, then, for example, iNB=0 A is output as the emergency operation current value. Since the A-side suction throttle is now completely open, the A-side rail pressure pCR(A) successively increases until the A-side passive pressure control valve responds. If the A-side pressure control valve opens, the A-side rail develops a rail pressure pCR(A) that is dependent on the operating point of the internal combustion engine. During idling, for example, pCR(A)=900 bars and at full load pCR(A)=700 bars, i.e., a mean rail pressure pCR(A) of 800 bars. This mean rail pressure is a very good approximation for emergency operating mode. However, opening of the A-side passive pressure control valve can also be effected if the set emergency operation current value iNB is set to a somewhat higher value, for example, iNB=0.4 A. This has the advantage that the greater fuel throttling does not lead to as much heating of the fuel as it is being redirected into the fuel tank.

Another possibility for triggering the opening of the A-side passive pressure control valve in emergency operating mode consists in setting a PWM emergency operation value PWMNB as the emergency operation triggering signal instead of the emergency operation current value iNB, for example, PWMNB=0%, as a preset point for the PWM computing unit 16A. In this example, the switch SR1 would then be arranged inside the PWM computing unit 16A. In another embodiment, a switch is made from the pump characteristic curve 15A to a limit curve. In this embodiment, the emergency operation triggering signal would then be the current iKL(A) computed by the limit curve. In FIG. 2, these variants are shown as broken-line output variables of functional block 20A.

FIG. 3 is a block diagram of the A-side closed-loop rail pressure control system 11A with emergency operating mode, the B-side closed-loop rail pressure control system 11B with emergency operating mode, an input-output map 21 for determining a set rail pressure pSL, an injector input-output map 22 for computing the energization time BD, a computing unit 23 for determining the set consumption VVb, and switches SR2 to SR7. The input variables of the block diagram are the engine speed nMOT, a set torque TSL, the A-side actual rail pressure pIST(A), the B-side actual rail pressure pIST(B), the rail pressure mean value pM, the signals RD(A) and RD(B), the firing order ZF, a set emergency operation rail pressure pNB(SL), and a set injection quantity QSL. The set injection quantity QSL is the correcting variable of the speed controller in a speed-controlled internal combustion engine. In an internal combustion engine that is not speed-controlled, the set injection quantity is derived from the engine power output desired by the operator, for example, from the accelerator pedal position. The output variables of the block diagram are the energization time BD of the injectors, the raw values pCR(A) of the A-side rail pressure, and the raw values pCR(B) of the B-side rail pressure.

In normal operating mode, the switches SR2 and SR3 are in position 1, since signal RD(A)=0. The A-side set rail pressure pSL(A) and the B-side set rail pressure pSL(B) thus correspond to the set rail pressure pSL. The set rail pressure pSL in turn is computed by the input-output map 21 as a function of the set torque TSL and the engine speed nMOT. In normal operating mode, i.e., when both rail pressure sensors are operating correctly, the switch SR7 is also in position 1. Therefore, the pressure pINJ is determined by the position of switch SR4. If switch SR4 is in position 1, the pressure pINJ is identical with the A-side actual rail pressure pIST(A), and if it is in position 2, the pressure pINJ is identical with the B-side actual rail pressure pIST(B). The position of switch SR4 varies as a function of the firing order ZF. If an A-side injector is being activated, the switch SR4 is in position 1, so that the energization time BD is computed by the injector input-output map 22 as a function of the set injection quantity QSL and the A-side actual rail pressure pIST(A). In this regard, switching occurs in such a way that the actual rail pressure corresponding to the injector currently being activated is always used by the injector input-output map 22 to compute the energization time BD.

If a defective A-side rail pressure sensor is now detected, a switch is made to A-side emergency operating mode, in which the A-side rail pressure is controlled by open-loop control. In the A-side emergency operating mode, the A-side rail pressure is successively increased until the A-side pressure control valve responds, as was described in the discussion of FIG. 2. The B-side rail pressure, on the other hand, continues to be controlled by closed-loop control. There are two embodiments for this. In the first embodiment, the switch SR3 remains in position 1, i.e., the B-side set rail pressure pSL(B) continues to be identical with the set rail pressure pSL, which is computed by the input-output map 21. In this case, the B-side rail continues to be operated with the optimal rail pressure, with the advantage of uniform emissions and high engine output. In the second embodiment, the B-side set rail pressure pSL(B) is set to the value of a set emergency operation rail pressure pNB(SL), for example, pNB(SL)=1500 bars, by changing the switch SR3 to position 2 by setting the signal RD(A). In the second embodiment, the pressure difference between the A-side actual rail pressure pIST(A), for example, 700 bars, and the B-side actual rail pressure pIST(B) is smaller than in the first embodiment. The smaller pressure difference results in quieter running in the emergency operating mode. If the B-side rail pressure sensor fails, the procedure is analogous to the procedure after failure of the A-side rail pressure sensor. The B-side closed-loop rail pressure control is deactivated and a change is made to open-loop control of the B-side rail pressure in the B-side emergency operating mode, while the A-side rail pressure continues to be controlled by closed-loop control. The A-side set rail pressure pSL(A) then corresponds either to the set rail pressure pSL in the first embodiment (SR2=1) or to the set emergency operation rail pressure pNB(SL) in the second embodiment (SR2=2).

The determination of the pressure pINJ in the case of emergency operating mode is characterized by the switch positions 2 to 4 of the switch SR7. If the B-side rail pressure sensor is defective, the signal RD(B) is set, which causes the switch SR7 to move into position 2. In this case, the pressure pINJ corresponds to the A-side actual rail pressure pIST(A) in switch position SR5=1 or to the rail pressure mean value pM in switch position SR5=2. The rail pressure mean value is established, for example, at pM=800 bars. Here too, the switching of the switch SR5 occurs as a function of the firing order ZF. If the A-side rail pressure sensor is defective, the signal RD(A) is set, so that the switch SR7 moves into position 3. In this case, the pressure pINJ is determined by switching from the mean pressure pM to the B-side actual rail pressure pIST(B) as a function of the firing order. If both rail pressure sensors are defective, then both signals RD(A) and RD(B) are set, which causes the switch SR7 to move into position 4. In this case, the actual rail pressures, which are no longer measurable, are now replaced by the mean rail pressure pM=800 bars independently of the firing order, which allows continued operation of the internal combustion engine at lower power output.

FIG. 4 shows a time chart that comprises four separate graphs 4A to 4D. In FIG. 4A, the signal RD(B) is drawn as a solid line, and the signal RD(A) is drawn as a dot-dash line. The signal RD(A) is set in the event of a defective A-side rail pressure sensor, and the signal RD(B) is set in the event of a defective B-side rail pressure sensor. FIG. 4B shows the A-side set rail pressure pSL(A) as a solid line and the A-side actual rail pressure pIST(A) as a broken line. FIG. 4C shows the B-side set rail pressure pSL(B) as a solid line and the B-side actual rail pressure pIST(B) as a broken line. FIG. 4D shows the A-side set current iSL(A) as a dot-dash line, the B-side set current iSL(B) as a solid line, and the B-side actual current ilST(B) as a broken line. The illustrated example was based on the embodiment in which, when emergency operating mode is set, the set value for the intact rail is set to the set emergency operation rail pressure pNB(SL). This is the second embodiment described in connection with FIG. 3.

At time t1, the B-side rail pressure sensor fails, i.e., the signal RD(B) is set to the value RD(B)=1. However, the A-side rail pressure sensor continues to operate correctly, i.e., the signal RD(A) remains at RD(A)=0. When the emergency operating mode is set at time t1 (see FIG. 4B), the A-side set value pSL(A)=2200 bars is switched to the set emergency operation rail pressure pNB(SL)=1500 bars by setting the switch SR2 to position 2 (SR2=2) (FIG. 3). Due to the new set value, the A-side actual rail pressure pIST(A) decreases starting at time t1 and approaches the A-side set rail pressure pSL(A) aperiodically. The B-side set rail pressure pSL(B) (see FIG. 4C) corresponds to the set rail pressure pSL computed by the input-output map 21 (FIG. 3), which also remains changed at pSL(B)=2200 bars, even after time t1. When the emergency operating mode is set at time t1, the B-side set current iSL(B) is set to the value of the emergency operation current value iNB=0 A by changing the switch SR1 in FIG. 2 to the position SR1=2. The B-side actual current iIST(B) follows this jump in the set value with a time delay, such that its course results from the energy stored in the suction throttle coil. Since the suction throttle is completely open in the absence of current, after time t1 the B-side actual rail pressure pIST(B) successively rises. At time t2, the passive pressure control valve opens, because the B-side actual rail pressure rises above the value pIST(B)=2400 bars. Fuel is redirected from the B-side rail into the fuel tank through the open pressure control valve, so that the B-side actual rail pressure drops to about pIST(B)=900 bars. Since the A-side rail pressure continues to be controlled by closed-loop control following failure of the B-side rail pressure sensor, the A-side set current iSL(A) and the A-side actual current iIST(A) are identical (see FIG. 4D).

FIG. 5 shows a first program flowchart for determining the pressure pINJ. The pressure pINJ is one input variable of the injector input-output map 22 (FIG. 3) for determining the energization time with which the injectors are activated. At S1 a check is performed to determine whether the A-side rail pressure sensor is defective, i.e., whether the signal RD(A)=1. If the A-side rail pressure sensor is not defective, the routine S2 to S8 is executed, otherwise the routine S9 to S13. If it was determined at S1 that the A-side rail pressure sensor is not defective (interrogation result S1: no), then at S2 a check is performed to determine whether the B-side rail pressure sensor is defective. If the B-side rail pressure sensor likewise is not defective (interrogation result S2: no), then an interrogation is performed at S3 to determine whether the next injection will occur on the A side. If this is the case (interrogation result S3: yes), then the pressure pINJ corresponds to the A-side actual rail pressure pIST(A) (S4). If, on the other hand, the next injection is to occur on the B side (interrogation result S3: no), then the pressure pINJ corresponds to the B-side actual rail pressure pIST(B) (S5). This routine is then ended. If it was determined at S2 that the B-side rail pressure sensor is defective (interrogation result S2: yes), then at S6 an interrogation is performed to determine whether the next injection will occur on the A side. If this is the case (interrogation result S6: yes), then the pressure pINJ corresponds to the A-side actual rail pressure pIST(A) (S7). If, on the other hand, the next injection is to occur on the B side (interrogation result S6: no), then at S8 the pressure pINJ is set to the rail pressure mean value pM, for example, pM=800 bars. This routine is then ended.

If a defective A-side rail pressure sensor was determined at S1 (interrogation result S1: yes), then a check is performed at S9 to determine whether the B-side rail pressure sensor is defective. If this is not the case (interrogation result S9: no), then at S10 an interrogation is performed to determine whether the next injection will occur on the A side. If this is not the case, i.e., the next injection will occur on the B side, then at S11 the pressure pINJ is set to the value of the B-side actual rail pressure pIST(B). If, on the other hand, the next injection will occur on the A side (interrogation result S10: yes), then at S12 the pressure pINJ is set to the rail pressure mean value pM, since, of course, the A-side rail pressure sensor is defective. If it was determined at S9 that the B-side rail pressure sensor is also defective (interrogation result S9: yes), then a double defect is present. In this case, then at S13 the pressure pINJ in general, i.e., independently of the firing order, is set to the rail pressure mean value pM. This routine is then ended.

FIG. 6 shows a second program flowchart. At S1 the A-side actual rail pressure pIST(A) is computed from the A-side raw values pCR(A). Then at S2 an interrogation is performed to determine whether a defective B-side rail pressure sensor was detected. If this is not the case (interrogation result S2: no), then at S3 the A-side set rail pressure pSL(A) is set to the value of the set rail pressure pSL, which in turn is computed by an input-output map (FIG. 3: 21) as a function of a set torque TSL and the engine speed nMOT. If, on the other hand, a defective B-side rail pressure sensor was detected at S2 (interrogation result S2: yes), then at S4 the A-side set rail pressure pSL(A) is set to the set emergency operation rail pressure pNB(SL), for example, pNB(SL)=1500 bars (SR2=2). Then at S5 the A-side control deviation ep(A) is computed as the deviation of the A-side actual rail pressure pIST(A) from the A-side set rail pressure pSL(A). At S6 the A-side control deviation ep(A) is used by the A-side pressure controller, for example, by means of a PIDT1 algorithm, to determine the A-side controller volume flow VR(A) as a correcting variable. At S7 the set consumption VVb is computed as a function of the set injection quantity QSL and the engine speed nMOT. Then at S8 the set consumption VVb is added to the A-side controller volume flow VR(A). The result represents the unlimited A-side set volume flow VSLu(A), which is then limited at S9 as a function of the engine speed. The result represents the A-side set volume flow VSL(A). Then at S10 a check is performed to determine whether the A-side rail pressure sensor is defective. If this is not the case, then at S11 the A-side set current iSL(A) is determined from the A-side set volume flow VSL(A) by the pump characteristic curve. If, on the other hand, the A-side rail pressure sensor is defective (interrogation result S10: yes), then at S12 the A-side set current iSL(A) is set to the emergency operation current value iNB (SR1=2). At S13 the A-side set current iSL(A) is then used to compute the A-side PWM signal PWM(A). The program is then ended.

### List of Reference Numbers

1 Internal Combustion Engine

2 Fuel Tank

3A, B Low-pressure Pump

4A, B Suction Throttle

5A, B High-pressure Pump

6A, B Rail

7A, B Injector

8A, B Rail Pressure Sensor

9A, B Pressure Control Valve, Passive

10 Electronic Control Unit (ECU)

11A, B Closed-loop Rail Pressure Control System (with emergency operating mode)

12A, B Filter

13A, B Pressure Controller

14A, B Limiter

15A, B Pump Characteristic Curve

16A, B PWM Signal Computing Unit

17A, B Unit (suction throttle and high-pressure pump)

18A, B closed-loop current control system

19A, B Filter

20A, B Emergency Operation Functional Block

21 Set Rail Pressure Input-output Map

22 Injector Input-output Map

23 Set Consumption Computing Unit

1-10. (canceled)

11. A method for open-loop and closed-loop control of an internal combustion engine with an A-side and a B-side common rail system, comprising the steps of: automatically controlling rail pressure of the common rail system on the A side and rail pressure of the common rail system on the B side independently of each other by an A-side closed-loop rail pressure control system and a B-side closed-loop rail pressure control system, respectively; and changing to A-side emergency operating mode if a defective A-side rail pressure sensor is detected, in which A-side emergency operating mode the A-side rail pressure is controlled by open-loop control, while the B-side rail pressure continues to be controlled by closed-loop control, or changing to B-side emergency operating mode, if a defective B-side rail pressure sensor is detected, in which B-side emergency operating mode the B-side rail pressure is controlled by open-loop control, while the A-side rail pressure continues to be controlled by closed-loop control.

12. The method in accordance with claim 11, further including changes to the emergency operating mode on both the A side and the B side, if a defective A-side rail pressure sensor and a defective B-side rail pressure sensor are detected.

13. The method in accordance with claim 11, wherein in the A-side emergency operating mode, the A-side rail pressure is successively increased until an A-side passive pressure control valve responds, and in the B-side emergency operating mode, the B-side rail pressure is successively increased until a B-side passive pressure control valve responds, where in an open state of a passive pressure control valve, fuel is redirected from the respective rail into the fuel tank.

14. The method in accordance with claim 13, including, in emergency operating mode, increasing the rail pressure by acting on the suction throttle on the low-pressure side, which serves as the pressure regulator, thereby causing the suction throttle to move in an opening direction.

15. The method in accordance with claim 14, including setting a set current to a PWM emergency operating value as a triggering signal of the suction throttle.

16. The method in accordance with claim 14, including setting a PWM signal to a PWM emergency operating value as a triggering signal of the suction throttle.

17. The method in accordance with claim 14, including, in normal operating mode, determining a set current as a triggering signal of the suction throttle by a pump characteristic curve, and in the emergency operating mode, determining the set current by a limit curve.

18. The method in accordance with claim 11, including in the A-side emergency operating mode, automatically adjusting the B-side rail pressure to a set emergency operation rail pressure, and in the B-side emergency operating mode, automatically adjusting the A-side rail pressure to the set emergency operation rail pressure.

19. The method in accordance with claim 11, including in normal operating mode, changing, as a function of firing order, from the A-side actual rail pressure to the B-side actual rail pressure as an input variable of an injector input-output map for computing an energization time of an injector, and in the A-side emergency operating mode, instead of the A-side actual rail pressure, setting a rail pressure mean value as the input variable, or in the B-side emergency operating mode, instead of the B-side actual rail pressure, setting the rail pressure mean value as the input variable.

20. The method in accordance with claim 19, including, in simultaneous A-side and B-side emergency operating mode, setting the rail pressure mean value as the input variable of the injector input-output map, independently of the firing order.
